(19) United States
(12) Patent Application Publication
(10) Pub. No.: US 2015/0191974 A1
(43) Pub. Date: Jul. 9, 2015

(54) GRAVITY FORWARD CLIMBING DEVICE

(71) Applicant: Hurricane Safety Systems, LLC, Traverse City, MI (US)

(72) Inventor: Timothy P. Squires, Williamsburg, MI (US)

(21) Appl. No.: 14/589,613

(22) Filed: Jan. 5, 2015

Related U.S. Application Data
(60) Provisional application No. 61/923,430, filed on Jan. 3, 2014.

(51) Int. Cl. E06C 1/06; E06C 7/00

(52) U.S. Cl. CPC E06C 1/06; E06C 7/00

(57) ABSTRACT

A climbing device includes a plurality of sections that are removably connected to each other at connection junctions. Each of the plurality of sections includes a standoff structure. The standoff structures have a variable length for each of the plurality of sections wherein the variable length positions each of the plurality of sections a specified distance from a climbing surface defining an angle of the climbing device relative to the climbing surface.

### CROSS-REFERENCE TO RELATED APPLICATIONS

This application claims priority of U.S. Provisional Application No. 61/923,430 filed Jan. 3, 2014, the contents of which are incorporated herein by reference.

### FIELD OF THE INVENTION

The invention relates to devices for climbing.

### BACKGROUND OF THE INVENTION

When climbing into a tree stand at an elevated level in a tree, users may climb a ladder, stick or other climbing device to get into a position to enter an elevated tree stand positioned in the tree. Often, such prior art climbing devices are positioned directly in line with the tree and attached to the tree. Such prior art climbing devices may force a user to resist a gravity force pulling the user in a backward direction off of the climbing device. Further, such prior art devices may put a large strain on a user climbing the device. There is therefore a need in the art for a climbing device that includes an angle of entry that provides a gravity assisting momentum to a user of the device that reduces the strain of climbing the device. There is also a need in the art for a climbing device that maintains the user's center of gravity in a forward position. There is a further need in the art for a climbing device that provides a predetermined angle of entry.

### SUMMARY OF THE INVENTION

In one aspect, there is disclosed a climbing device that includes a plurality of sections that are removably connected to each other at connection junctions. Each of the plurality of sections includes a standoff structure. The standoff structures have a variable length for each of the plurality of sections wherein the variable length positions each of the plurality of sections a specified distance from a climbing surface defining an angle of the climbing device relative to the climbing surface.

In another aspect, there is disclosed a climbing device that includes a plurality of sections that are removably connected to each other at connection junctions. Each of the plurality of sections includes a standoff structure. The standoff structures have a variable length for each of the plurality of sections wherein the variable length positions each of the plurality of sections a specified distance from a climbing surface defining an angle of entry A as steps of the climbing device are angled away from the climbing surface at a specified interval wherein the angle of entry A maintains a user's center of gravity in a forward position.

In a further aspect, there is disclosed a climbing device that includes a plurality of sections that are removably connected to each other at connection junctions. Each of the plurality of sections includes a standoff structure. The standoff structures have a variable length for each of the plurality of sections wherein the variable length positions each of the plurality of sections a specified distance from a climbing surface defining an angle of the climbing device relative to the climbing surface. The variable length of the standoff structures includes a lowest section of the climbing device having the standoff structure having the greatest length corresponding to a greater distance from the climbing surface with each of the sections above the lowest section having a decreasing length.

### BRIEF DESCRIPTION OF THE DRAWINGS

FIG. 1 is side view detailing one embodiment of the climbing device positioned on a climbing surface;

FIG. 2 is a section view of the climbing device and climbing surface along the line A-A of FIG. 1;

FIG. 3 is a front view of the climbing device of FIG. 1;

FIG. 4 is a perspective view of climbing device of FIG. 1;

FIG. 5 is side view detailing another embodiment of the climbing device positioned on a climbing surface;

FIG. 6 is a section view of the climbing device and climbing surface along the line A-A of FIG. 5;

FIG. 7 is a front view of the climbing device of FIG. 5;

FIG. 8 is a perspective view of climbing device of FIG. 5;

FIG. 9 is side view detailing a further embodiment of the climbing device positioned on a climbing surface;

FIG. 10 is a section view of the climbing device and climbing surface along the line A-A of FIG. 9;

FIG. 11 is a front view of the climbing device of FIG. 9;

FIG. 12 is a perspective view of climbing device of FIG. 9;

FIG. 13 is a vector diagram of the climbing device and a climbing surface.

### DETAILED DESCRIPTION OF THE PREFERRED EMBODIMENTS

Referring to the Figures, there is shown a gravity forward climbing device 20 that includes a plurality of sections 22 that are connected to each other at connection junctions 23. The connection junctions 23 may include a male portion 26 that is inserted into a female portion of an adjacent section 22 of the climbing device 20. The sections 22 are connected to each other to define the climbing device 20. Various numbers of sections 22 having various lengths may be utilized. Each of the sections 22 includes a standoff structure 24 that engages a climbing surface 26 and positions the section 22 at a specified distance from the climbing surface 26. The standoff structures 24 of each of the sections 22 have a variable length such that an angle of the climbing device 20 relative to the climbing surface 26 is predefined. In one aspect, the lowest section 28 of the climbing device 20 has the standoff structure 24 having the greatest length corresponding to a greater distance from the climbing surface 26 with each of the sections 22 above having a decreasing length. In this manner, a predetermined angle of entry A is defined as the steps of the climbing device 20 are angled away from the climbing surface 26 at a specified interval. The angle of entry A provides a gravity assisting momentum to a user of the device that reduces the strain of climbing the device, as well as maintains the user's center of gravity in a forward position, as will be described in more detail below.

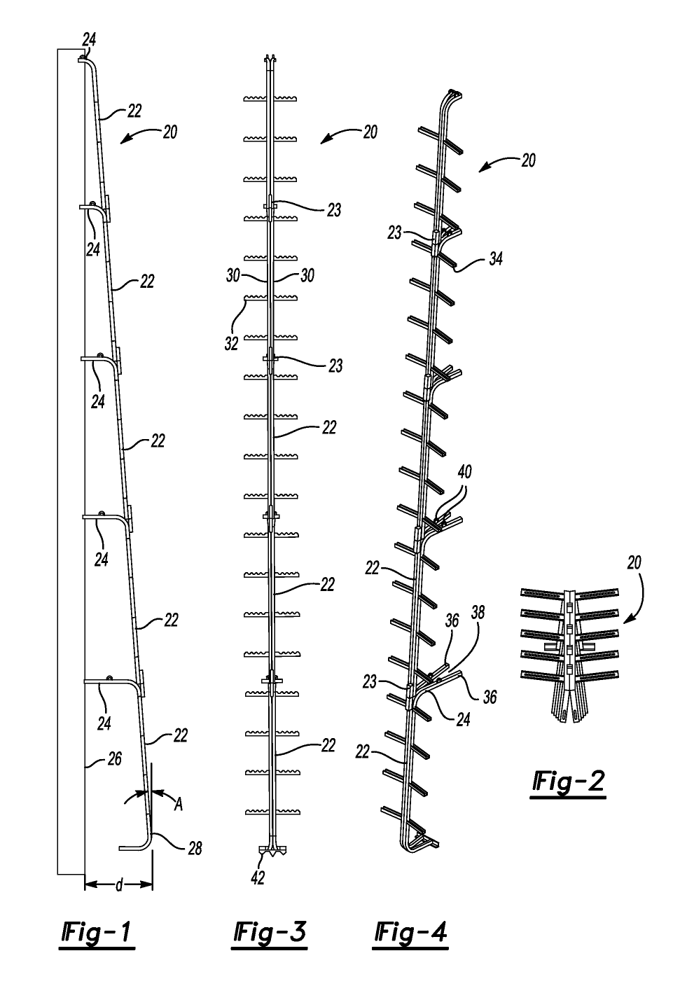

Referring to FIGS. 1 through 4, the climbing device 20 may include sections 22 that include a pair center rails 30 having steps 32 attached along the center rails 30 at specified intervals. The steps 32 may be attached to center rails 30 at an angle as best shown on FIGS. 2 and 4. The steps 32 may include a tread surface 34 that includes knurls or shapes to aid in gripping the sole of a user's foot as they climb.

The sections 22 may be attached to each other at the connection junctions 23 with the male tube section of one of the sections 22 being inserted into a female tube section of an adjacent section 22. As specified above various numbers of sections 22 having various lengths may be utilized. In one aspect, the climbing device 20 may have a total length of from 12 to 25 feet and may include various numbers of sections 22.

The standoff structure 24 includes a pair of extensions 36 that separate from each other at an angle to define a V-shaped structure 38. The climbing surface 26 may be received in each of the V-shaped structures 38 of the section 22 to secure the climbing device to the climbing surface 26. The standoff structures 24 may also include attachment points 40 attached to the extensions 36 to allow for passage of a cable or other device to secure the sections 22 relative to the climbing surface 26.

As detailed above, the lower section 28 includes the standoff structure 24 with the greatest length with each of the sections 22 above having a decreasing length to define the angle of entry A of the climbing device 20. In one aspect, the lowest section 28 may include a spike or other such structure 42 to maintain the position of the lower section 28 in the ground.

In one aspect the lower section 28 may be positioned a distance d at the base of from 10 to 30 inches from the climbing surface. The lengths of the standoff structures may decrease upward such that the angle of entry A may vary from 4 to 10 degrees as measured relative to a vertical line of the climbing surface.

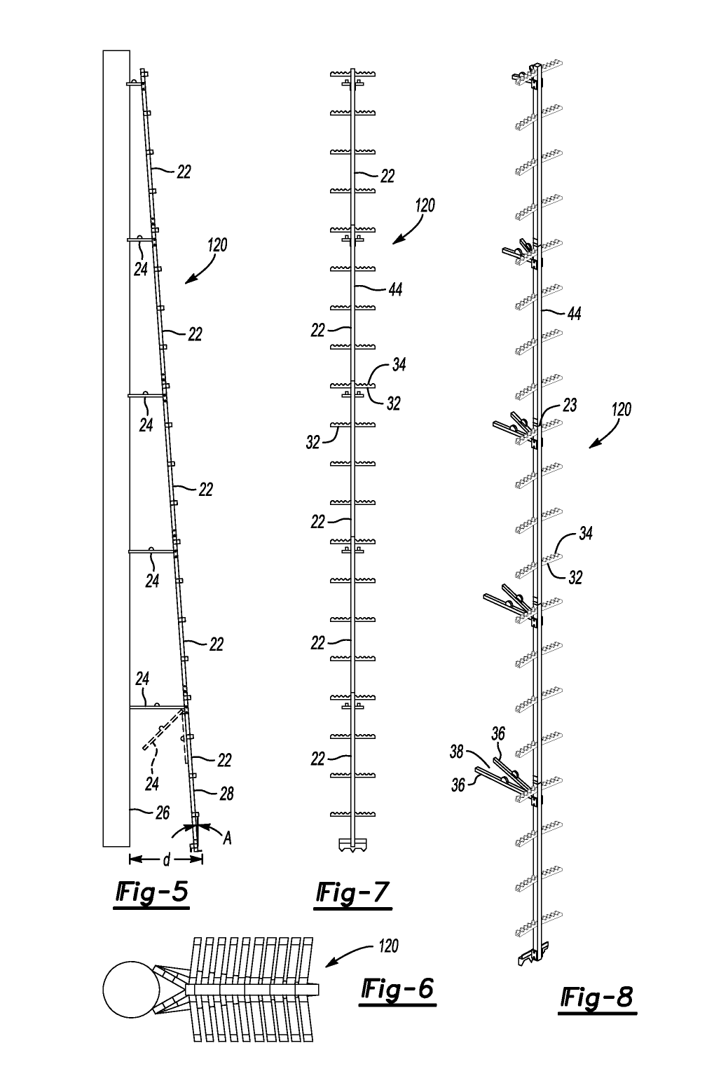

Referring to FIGS. 5 through 8, there is shown an alternative embodiment of a climbing device 120. The climbing device 120 includes a similar structure to that of FIGS. 1-4 including the plurality of sections 22, steps 32 and other structures described above, except that there is a single center rail 44 as opposed to the pair of center rails 30 shown in the previous embodiment. Additionally, the standoff structure 24 may be pivotally attached to the center rail 44 such that it can be folded for storage when the climbing device is not installed on a climbing surface 26. In one aspect the lower section 28 may be positioned a distance d at the base of from 10 to 30 inches from the climbing surface. The lengths of the standoff structures 24 may decrease upward such that the angle of entry A may vary from 4 to 10 degrees as measured relative to a vertical line of the climbing surface.

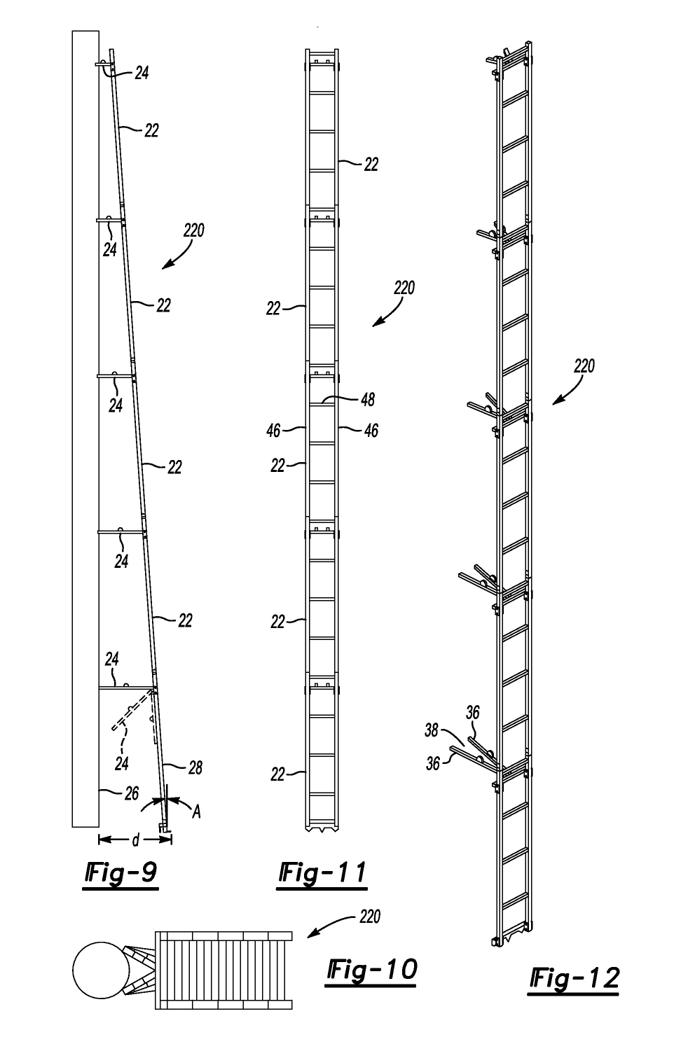

Referring to FIGS. 9-12 there is shown another embodiment of a climbing device 220. The climbing device 220 also includes a plurality of sections 22 that are connected to each other. The sections 22 include a pair of outer rails 46 spaced from each other and joined by treads 48 to define a ladder type structure. As described above the sections 22 may be joined to each other with the outer rails 46 of one of the sections 22 received in the rail 46 of an adjacent section 22. As with the embodiment of FIGS. 5-8, the standoff structures 24 may be pivotally attached such that it can be folded for storage when the climbing device is not installed on a climbing surface 26. In one aspect, the lower section 28 may be positioned a distance d at the base of from 10 to 30 inches from the climbing surface. The lengths of the standoff structures 24 may decrease upward such that the angle of entry A may vary from 4 to 10 degrees as measured relative to a vertical line of the climbing surface 26.

In use, a user may assemble the sections 22 of the climbing device 20, 120, 220 such that the standoff sections 24 decrease in length from the lower most section 28 to the upper most section. The rails 30, 44, 46 of the various sections may be connected to each other by inserting the rail of an adjacent section into the other section's rail. The standoff structures 24 are positioned against the climbing surface 26 such that a predetermined angle of entry is provided. The rail sections 22 may be attached to the climbing surface 26 using a cable and the attachment points 40 as described above.

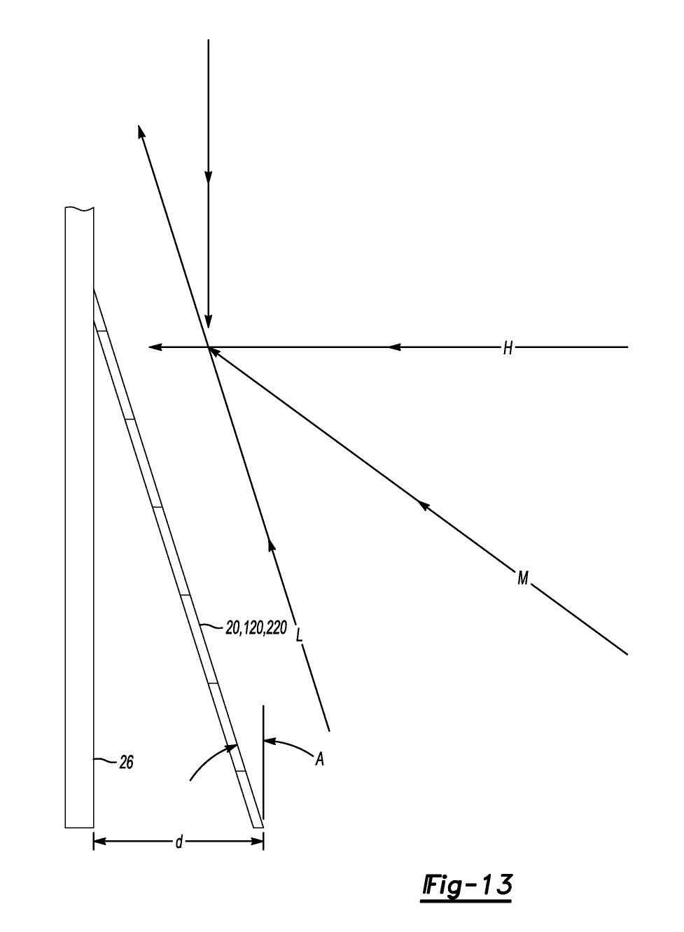

A user's momentum M, as shown in the vector positioned between the arc defined between lines L and H of FIG. 13, is in a forward position as compared to scaling a vertical surface if the climbing device was attached along the length of the climbing surface. In this manner, a predetermined angle of entry A is defined as the steps of the climbing device 20 are angled away from the climbing surface 26 at a specified interval. The angle of entry A provides a gravity assisting momentum to a user of the device that reduces the strain of climbing the device, as well as maintains the user's center of gravity in a forward position.

We claim:

1. A climbing device comprising:
a plurality of sections removably connected to each other at connection junctions, each of the plurality sections including a standoff structure, the standoff structures having a variable length for each of the plurality of sections wherein the variable length positions each of the plurality of sections a specified distance from a climbing surface defining an angle of the climbing device relative to the climbing surface.

2. The climbing device of claim 1 wherein the connection junctions include male and female portions of the plurality of sections wherein the male portion is inserted within the female portion of an adjacent section.

3. The climbing device of claim 1 wherein the variable length of the standoff structures includes a lowest section of the climbing device having the standoff structure having the greatest length corresponding to a greater distance from the climbing surface with each of the sections above the lowest section having a decreasing length.

4. The climbing device of claim 3 wherein a predetermined angle of entry A is defined as steps of the climbing device are angled away from the climbing surface at a specified interval.

5. The climbing device of claim 4 wherein the angle of entry A provides a gravity assisting momentum to a user of the device that reduces the strain of climbing the device.

6. The climbing device of claim 4 wherein the angle of entry A maintains a user's center of gravity in a forward position.

7. The climbing device of claim 1 wherein the standoff structures include a pair of extensions that separate from each other at an angle to define a V-shaped structure, the climbing surface received in each of the V-shaped structures securing the climbing device to the climbing surface.

8. The climbing device of claim 7 wherein the standoff structures include attachment points attached to the extensions allowing passage of a cable to secure the sections relative to the climbing surface.

9. The climbing device of claim 1 wherein the sections include a pair of center rails having steps attached along the center rails at specified intervals.

10. The climbing device of claim 9 wherein the steps are attached to the center rails at an angle, the steps including a tread surface.

11. The climbing device of claim 1 wherein the sections include a center rail having steps attached along the center rails at specified intervals.

12. The climbing device of claim 11 wherein the standoff structure is pivotally attached to the center rail such that it can be folded for storage when the climbing device is not installed on the climbing surface.

13. The climbing device of claim 1 wherein the sections include a pair of outer rails spaced from each other and joined by.

14. The climbing device of claim 13 wherein the standoff structure is pivotally attached to the center rail such that it can be folded for storage when the climbing device is not installed on the climbing surface.

15. The climbing device of claim 3 wherein the lowest section includes a spike maintaining a position of the lower section relative to a ground.

16. The climbing device of claim 3 wherein the lowest section is positioned a distance d at the base of from 10 to 30 inches from the climbing surface.

17. The climbing device of claim 4 wherein the lengths of the standoff structures decrease upward such that the angle of entry A is from 4 to 10 degrees as measured relative to a vertical line of the climbing surface.

18. A climbing device comprising:
a plurality of sections removably connected to each other at connection junctions, each of the plurality sections including a standoff structure, the standoff structures having a variable length for each of the plurality of sections wherein the variable length positions each of the plurality of sections a specified distance from a climbing surface defining a predetermined angle of entry A as steps of the climbing device are angled away from the climbing surface at a specified interval wherein the angle of entry A maintains a user's center of gravity in a forward position.

19. The climbing device of claim 18 wherein the lengths of the standoff structures decrease upward such that the angle of entry A is from 4 to 10 degrees as measured relative to a vertical line of the climbing surface.

20. A climbing device comprising:
a plurality of sections removably connected to each other at connection junctions, each of the plurality sections including a standoff structure, the standoff structures having a variable length for each of the plurality of sections wherein the variable length positions each of the plurality of sections a specified distance from a climbing surface defining an angle of the climbing device relative to the climbing surface wherein the variable length of the standoff structures includes a lowest section of the climbing device having the standoff structure having the greatest length corresponding to a greater distance from the climbing surface with each of the sections above the lowest section having a decreasing length.

21. The climbing device of claim 20 wherein the lowest section is positioned a distance d at the base of from 10 to 30 inches from the climbing surface.
